(19) United States
(12) Patent Application Publication
(10) Pub. No.: US 2004/0133769 A1
(43) Pub. Date: Jul. 8, 2004

(54) Generating prefetches by speculatively executing code through hardware scout threading

(76) Inventors: Shailender Chaudhry, San Francisco, CA (US); Marc Tremblay, Menlo Park, CA (US)

Correspondence Address: PARK, VAUGHAN & FLEMING LLP, 508 SECOND STREET, SUITE 201, DAVIS, CA, 95616, US

(21) Appl. No.: 10/741,944

(22) Filed: Dec. 19, 2003

Related U.S. Application Data
(60) Provisional application No. 60/436,539, filed on Dec. 24, 2002.

(51) Int. Cl. G06F 15/00; G06F 9/00

(52) U.S. Cl. 712/233; 712/207

(57) ABSTRACT

One embodiment of the present invention provides a system that generates prefetches by speculatively executing code during stalls through a technique known as “hardware scout threading.” The system starts by executing code within a processor. Upon encountering a stall, the system speculatively executes the code from the point of the stall, without committing results of the speculative execution to the architectural state of the processor. If the system encounters a memory reference during this speculative execution, the system determines if a target address for the memory reference can be resolved. If so, the system issues a prefetch for the memory reference to load a cache line for the memory reference into a cache within the processor.

### RELATED APPLICATIONS

This application hereby claims priority under 35 U.S.C. §119 to U.S. Provisional Patent Application No. 60/436,539, filed on 24 Dec. 2002, entitled “Generating Prefetches by Speculatively Executing Code Through Hardware Scout Threading,” by inventors Shailender Chaudhry and Marc Tremblay (Attorney Docket No. SUN-P8383PSP). The subject matter of this application is also related to the subject matter in a co-pending non-provisional application by the same inventors as the instant application and filed on the same day as the instant application entitled, “Performing Hardware Scout Threading in a System that Supports Simultaneous Multithreading,” having serial number TO BE ASSIGNED, and filing date TO BE ASSIGNED (Attorney Docket No. SUN-P8386-MEG).

### BACKGROUND

1. Field of the Invention

The present invention relates to the design of processors within computer systems. More specifically, the present invention relates to a method and an apparatus for generating prefetches by speculatively executing code during stall conditions through hardware scout threading.

2. Related Art

Recent increases in microprocessor clock speeds have not been matched by corresponding increases in memory access speeds. Hence, the disparity between microprocessor clock speeds and memory access speeds continues to grow. Execution profiles for fast microprocessor systems show that a large fraction of execution time is spent, not within the microprocessor core, but within memory structures outside of the microprocessor core. This means that microprocessors spend a large fraction of time stalled waiting for memory references to complete instead of performing computational operations.

As more processor cycles are required to perform a memory access, even processors that support “out-of order execution” are unable to effectively hide memory latency. Designers are continuing to increase the size of instruction windows in out-of-order machines in an attempt to hide additional memory latency. However, increasing instruction window size consumes chip area and introduces additional propagation delay into the processor core, which can degrade microprocessor performance.

A number of compiler-based techniques have been developed to insert explicit prefetch instructions into executable code in advance of where the prefetched data items are required. Such prefetching techniques can be effective in generating prefetches for data access patterns having a regular “stride”, which allows subsequent data accesses to be accurately predicted. However, existing compiler-based techniques are not effective in generating prefetches for irregular data access patterns, because the cache behavior of these irregular data access patterns cannot be predicted at compile-time.

Hence, what is needed is a method and an apparatus that hides memory latency without the above-described problems.

### SUMMARY

One embodiment of the present invention provides a system that generates prefetches by speculatively executing code during stalls through a technique known as “hardware scout threading.” The system starts by executing code within a processor. Upon encountering a stall, the system speculatively executes the code from the point of the stall, without committing results of the speculative execution to the architectural state of the processor. If the system encounters a memory reference during this speculative execution, the system determines if a target address for the memory reference can be resolved. If so, the system issues a prefetch for the memory reference to load a cache line for the memory reference into a cache within the processor.

In a variation on this embodiment, the system maintains state information indicating whether values in the registers have been updated during speculative execution of the code.

In a variation on this embodiment, during speculative execution of the code, instructions update a shadow register file, instead of updating an architectural register file, so that the speculative execution does not affect the architectural state of the processor.

In a further variation, a read from a register during speculative execution accesses the architectural register file, unless the register has been updated during speculative execution, in which case the read accesses the shadow register file.

In a variation on this embodiment, the system maintains a “write bit” for each register, indicating whether the register has been written to during speculative execution. The system sets the write bit of any register that is updated during speculative execution.

In a variation on this embodiment, the system maintains state information indicating if the values within the registers can be resolved during speculative execution.

In a further variation, this state information includes a “not there bit” for each register, indicating whether a value in the register can be resolved during speculative execution. During speculative execution, the system sets the not there bit of a destination register for a load if the load has not returned a value to the destination register. The system also sets the not there bit of a destination register if the not there bit of any corresponding source register of is set.

In a further variation, determining if an address for the memory reference can be resolved involves examining the “not there bit” of a register containing the address for the memory reference, wherein the not there bit being set indicates the address for the memory reference cannot be resolved.

In a variation on this embodiment, when the stall completes, the system resumes non-speculative execution of the code from the point of the stall.

In a further variation, resuming non-speculative execution of the code involves: clearing “not there bits” associated with the registers; clearing “write bits” associated with the registers; clearing a speculative store buffer; and performing a branch mispredict operation to resume execution of the code from the point of the stall.

In a variation on this embodiment, the system maintains a speculative store buffer containing data written to memory locations by speculative store operations. This allows subsequent speculative load operations directed to the same memory locations to access data from the speculative store buffer.

In a variation on this embodiment, stall can include: a load miss stall, a store buffer full stall, or a memory barrier stall.

In a variation on this embodiment, speculatively executing the code involves skipping execution of floating-point and other long latency instructions.

In a variation on this embodiment, the processor supports simultaneous multithreading (SMT), which enables multiple threads to execute concurrently through time-multiplexed interleaving in a single processor pipeline. In this variation, the non-speculative execution is carried out by a first thread and the speculative execution is carried out by a second thread, wherein the first thread and the second thread simultaneously execute on the processor.

### BRIEF DESCRIPTION OF THE FIGURES

FIG. 1 illustrates a processor within a computer system in accordance with an embodiment of the present invention.

FIG. 2 presents a flow chart illustrating the speculative execution process in accordance with an embodiment of the present invention.

FIG. 3 illustrates a processor that supports simultaneous multithreading in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Processor

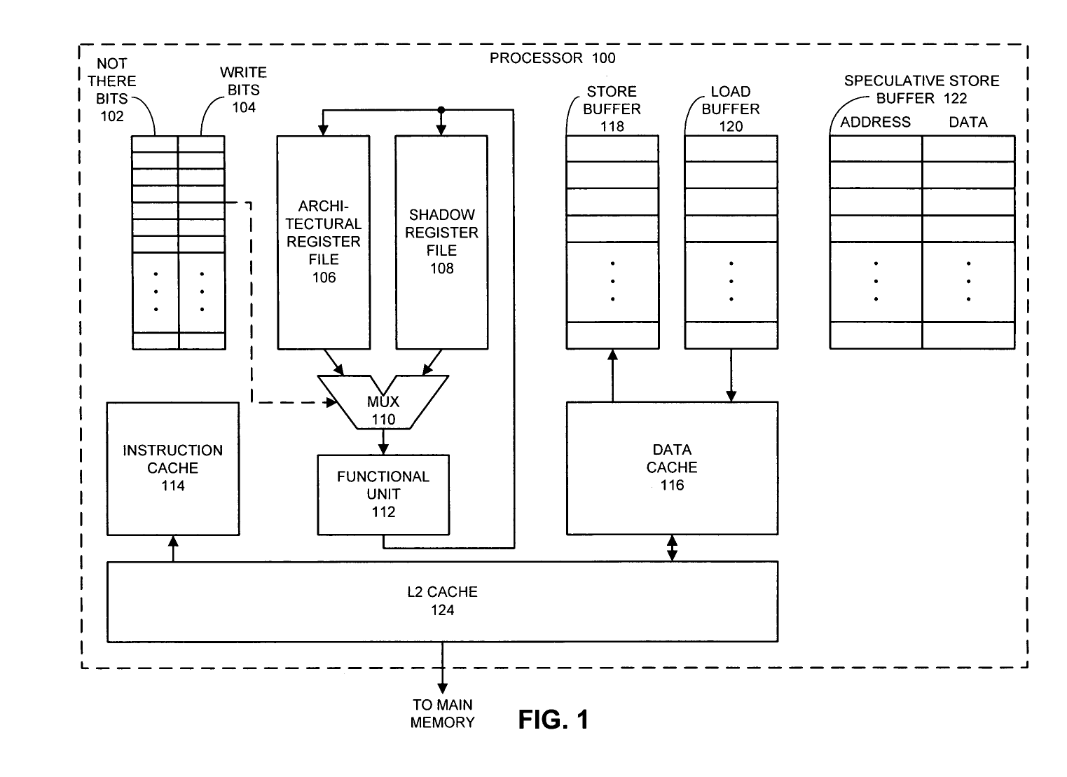

FIG. 1 illustrates a processor 100 within a computer system in accordance with an embodiment of the present invention. The computer system can generally include any type of computer system, including, but not limited to, a computer system based on a microprocessor, a mainframe computer, a digital signal processor, a portable computing device, a personal organizer, a device controller, and a computational engine within an appliance.

Processor 100 contains a number of hardware structures found in a typical microprocessor. More specifically, processor 100 includes and architectural register file 106, which contains operands to be manipulated by processor 100. Operands from architectural register file 106 pass through a functional unit 112, which performs computational operations on the operands. Results of these computational operations return to destination registers in architectural register file 106.

Processor 100 also includes instruction cache 114, which contains instructions to be executed by processor 100, and data cache 1116, which contains data to be operated on by processor 100. Data cache 116 and instruction cache 114 are coupled to Level-Two cache (L2) cache 124, which is coupled to memory controller 111. Memory controller 111 is coupled to main memory, which is located off chip. Processor 100 additionally includes load buffer 120 for buffering load requests to data cache 116, and store buffer 118 for buffering store requests to data cache 116.

Processor 100 additionally contains a number of hardware structures that do not exist in a typical microprocessor, including shadow register file 108, “not there bits” 102, “write bits” 104, multiplexer (MUX) 110 and speculative store buffer 122.

Shadow register file 108 contains operands that are updated during speculative execution in accordance with an embodiment of the present invention. This prevents speculative execution from affecting architectural register file 106. (Note that a processor that supports out-of-order execution can also save its name table—in addition to saving its architectural registers—prior to speculative execution.)

Note that each register in architecture register file 106 is associated with a corresponding register in shadow register file 108. Each pair of corresponding registers is associated with a “not there bit” (from not there bits 102). If a not there bit is set, this indicates that the contents of the corresponding register cannot be resolved. For example, the register may be awaiting a data value from a load miss that has not yet returned, or the register may be waiting for a result of an operation that has not yet returned (or an operation that is not performed) during speculative execution.

Each pair of corresponding registers is also associated with a “write bit” (from write bits 104). If a write bit is set, this indicates that the register has been updated during speculative execution, and that subsequent speculative instructions should retrieve the updated value for the register from shadow register file 108.

Operands pulled from architectural register file 106 and shadow register file 108 pass through MUX 110. MUX 110 selects an operand from shadow register file 108 if the write bit for the register is set, which indicates that the operand was modified during speculative execution. Otherwise, MUX 110 retrieves the unmodified operand from architectural register file 106.

Speculative store buffer 122 keeps track of addresses and data for store operations to memory that take place during speculative execution. Speculative store buffer 122 mimics the behavior of store buffer 118, except that data within speculative store buffer 122 is not actually written to memory, but is merely saved in speculative store buffer 122 to allow subsequent speculative load operations directed to the same memory locations to access data from the speculative store buffer 122, instead of generating a prefetch.

Speculative Execution Process

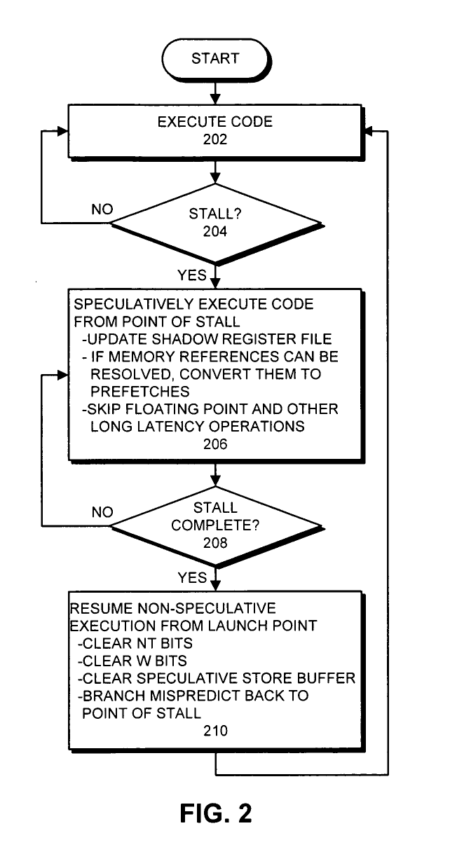

FIG. 2 presents a flow chart illustrating the speculative execution process in accordance with an embodiment of the present invention. The system starts by executing code non-speculatively (step 202). Upon encountering a stall condition during this non-speculative execution, the system speculatively executes code from the point of the stall (step 206). (Note that the point of the stall is also referred to as the “launch point.”)

In general, the stall condition can include and type of stall that causes a processor to stop executing instructions. For example, the stall condition can include a “load miss stall” in which the processor waits for a data value to be returned during a load operation. The stall condition can also include a “store buffer full stall,” which occurs during a store operation, if the store buffer is full and cannot accept a new store operation. The stall condition can also include a “memory barrier stall,” which takes place when a memory barrier is encountered and processor has to wait for the load buffer and/or the store buffer to empty. In addition to these examples, any other stall condition can trigger speculative execution. Note that an out-of-order machine will have a different set of stall conditions, such as an “instruction window full stall.”

During the speculative execution in step 206, the system updates the shadow register file 108, instead of updating architectural register file 106. Whenever a register in shadow register file 108 is updated, a corresponding write bit for the register is set.

If a memory reference is encountered during speculative execution, the system examines the not there bit for the register containing the target address of the memory reference. If the not there bit of this register is unset, indicating the address for the memory reference can be resolved, the system issues a prefetch to retrieve a cache line for the target address. In this way, the cache line for the target address will be loaded into cache when normal non-speculative execution ultimately resumes and is ready to perform the memory reference. Note that this embodiment of the present invention essentially converts speculative stores into prefetches, and converts speculative loads into loads to shadow register file 108.

The not there bit of a register is set whenever the contents of the register cannot be resolved. For example, as was described above, the register may be waiting for a data value to return from a load miss, or the register may be waiting for the result of an operation that has not yet returned (or an operation that is not performed) during speculative execution. Also note that the not there bit for a destination register of a speculatively executed instruction is set if any of the source registers for the instruction have their not bits that are set, because the result of the instruction cannot be resolved if one of the source registers for the instruction contains a value that cannot be resolved. Note that during speculative execution a not there bit that is set can be subsequently cleared if the corresponding register is updated with a resolved value.

In one embodiment of the present invention, the systems skips floating point (and possibly other long latency operations, such as MUL, DIV and SQRT) during speculative execution, because the floating-point instructions are unlikely to affect address computations. Note that the not there bit for the destination register of an instruction that is skipped must be set to indicate that the value in the destination register has not been resolved.

When the stall conditions completes, the system resumes normal non-speculative execution from the launch point (step 210). This can involve performing a “flash clear” operation in hardware to clear not there bits 102, write bits 104 and speculative store buffer 122. It can also involve performing a “branch mispredict operation” to resume normal non-speculative execution from the launch point. Note that that a branch mispredict operation is generally available in processors that include a branch predictor. If a branch is mispredicted by the branch predictor, such processors use the branch mispredict operation to return to the correct branch target in the code.

In one embodiment of the present invention, if a branch instruction is encountered during speculative execution, the system determines if the branch is resolvable, which means the source registers for the branch conditions are “there.” If so, the system performs the branch. Otherwise, the system defers to a branch predictor to predict where the branch will go.

Note that prefetch operations performed during the speculative execution are likely to improve subsequent system performance during non-speculative execution.

Also note that the above-described process is able to operate on a standard executable code file, and hence, is able to work entirely through hardware, without any compiler involvement.

SMT Processor

Note that many of the hardware structures used for speculative execution, such as shadow register file 108 and speculative store buffer 122, are similar to structures that exist in processors that support simultaneous multithreading (SMT). Hence, it is possible to modify an SMT processor, for example by adding “not there bits” and “write bits,” and by making other modifications, to enable an SMT processor to perform hardware scout threading. In this way, a modified SMT architecture can be used to speed up a single application, instead of increasing throughput for a set of unrelated applications,

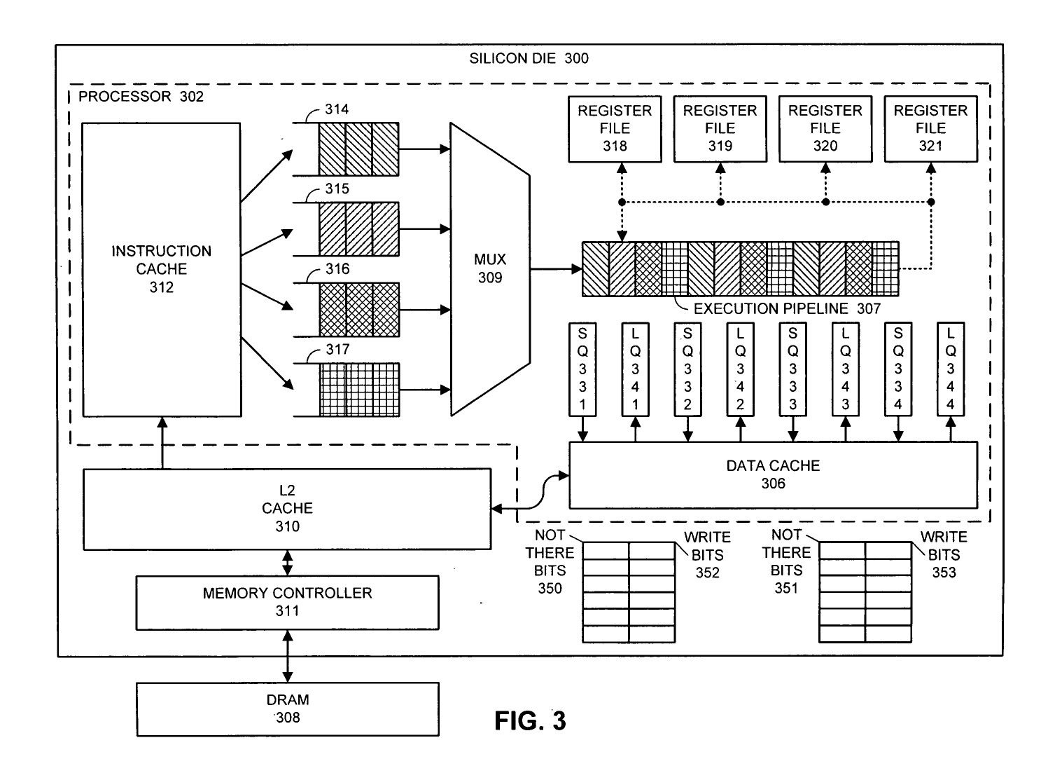

FIG. 3 illustrates a processor that supports simultaneous multithreading in accordance with an embodiment of the present invention. In this embodiment, silicon die 300 contains at least one processor 302. Processor 302 can generally include any type of computational devices that allow multiple threads to execute concurrently.

Processor 302 includes instruction cache 312, which contains instructions to be executed by processor 302, and data cache 306, which contains data to be operated on by processor 302. Data cache 306 and instruction cache 312 are coupled to level-two cache (L2) cache, which is itself coupled to memory controller 311. Memory controller 311 is coupled to main memory, which is located off chip.

Instruction cache 312 feeds instructions into four separate instruction queues 314-317, which are associated with four separate threads of execution. Instructions from instruction queues 314-317 feed through multiplexer 309, which interleaves instructions in round-robin fashion before they feed into execution pipeline 307. As illustrated in FIG. 3, instructions from a given instruction queue occupy every fourth instruction slot in execution pipeline 307. Note that other implementations of processor 302 can possibly interleave instructions from more than four queues, or alternatively, less than four queues.

Because the pipeline slots rotate between different threads, latencies can be relaxed. For example, a load from data cache 306 can take up to four pipeline stages, or an arithmetic operation can take up to four pipeline stages, without causes a pipeline stall. In one embodiment of the present invention, this interleaving is “static,” which means that each instruction queue is associated with every fourth instruction slot in execution pipeline 307, and this association is does not change dynamically over time.

Instruction queues 314-317 are associated with corresponding register files 318-321, respectively, which contain operands that are manipulated by instructions from instruction queues 314-317. Note that instructions in execution pipeline 307 can cause data to be transferred between data cache 306 and register files 318-319. (In another embodiment of the present invention, register files 318-321 are consolidated into a single large multi-ported register file that is partitioned between the separate threads associated with instruction queues 314-317.)

Instruction queues 314-317 are also associated with corresponding store queues (SQs) 331-334 and load queues (LQs) 341-344. (In another embodiment of the present invention, store queues 331-334 are consolidated into a single large store queue, which is partitioned between the separate threads associated with instruction queues 314-317, and load queues 341-344 are similarly consolidated into a single large load queue.)

When a thread is executing speculatively, the associated store queue is modified to function like speculative store buffer 122 described above with reference to FIG. 1. Recall that data within speculative store buffer 122 is not actually written to memory, but is merely saved to allow subsequent speculative load operations directed to the same memory locations to access data from the speculative store buffer 122, instead of generating a prefetch.

Processor 302 also includes two sets of “not there bits” 350-351, and two sets of “write bits” 352-353. For example, not there bits 350 and write bits 352 can be associated with register files 318-319. This enables register file 318 to functions as an architectural register file and register file 319 to function as corresponding shadow register file to support speculative execution. Similarly, not there bits 351 and write bits 353 can be associated with register files 320-321, which enables register file 320 to function as an architectural register file and register file 321 to function as a corresponding shadow register file. Providing two sets of not there bits and write bits allows processor 302 to support up to two speculative threads.

Note that the SMT variant of the present invention generally applies to any computer system that supports concurrent interleaved execution of multiple threads in a single pipeline and is not meant to be limited to the illustrated computing system.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for generating prefetches by speculatively executing code during stalls, comprising:
executing code within a processor;
upon encountering a stall during execution of the code, speculatively executing the code from the point of the stall, without committing results of the speculative execution to the architectural state of the processor; and
upon encountering a memory reference during the speculative execution of the code,
determining if a target address for the memory reference can be resolved, and
if the target address for the memory reference can be resolved, issuing a prefetch for the memory reference to load a cache line for the memory reference into a cache within the processor.

2. The method of claim 1, further comprising maintaining state information indicating whether values in the registers have been updated during speculative execution of the code.

3. The method of claim 2, wherein during speculative execution of the code, the method updates a shadow register file, instead of updating an architectural register file, so that the speculative execution does not affect the architectural state of the processor.

4. The method of claim 3, wherein a read from a register during speculative execution of the code accesses the architectural register file, unless the register has been updated during speculative execution, in which case the read accesses the shadow register file.

5. The method of claim 2, wherein maintaining the state information indicating whether values in the registers have been updated during speculative execution involves:
maintaining a “write bit” for each register, indicating whether the register has been written to during speculative execution; and
setting the write bit of any register that is updated during speculative execution.

6. The method of claim 1, further comprising maintaining state information indicating if the values within the registers can be resolved during speculative execution.

7. The method of claim 6, wherein maintaining state information indicating if the values within the registers can be resolved during speculative execution involves:
maintaining a “not there bit” for each register, indicating whether a value in the register can be resolved during speculative execution;
setting the not there bit of a destination register for a load during speculative execution if the load has not returned a value to the destination register; and
setting the not there bit of a destination register of an instruction during speculative execution if the not there bit of any source register of the instruction is set.

8. The method of claim 7, wherein determining if an address for the memory reference can be resolved involves examining the “not there bit” of a register containing the address for the memory reference, wherein the not there bit being set indicates the address for the memory reference cannot be resolved.

9. The method of claim 1, wherein when the stall completes, the method further comprises resuming non-speculative execution of the code from the point of the stall.

10. The method of claim 9, wherein resuming non-speculative execution of the code involves:
clearing “not there bits” associated with the registers;
clearing “write bits” associated with the registers;
clearing a speculative store buffer; and
performing a branch mispredict operation to resume execution of the code from the point of the stall.

11. The method of claim 1, further comprising:
maintaining a speculative store buffer containing data written to memory locations by speculative store operations; and
allowing subsequent speculative load operations directed to the same memory locations to access data from the speculative store buffer.

12. The method of claim 1, wherein the stall can include:
a load miss stall;
a store buffer full stall; and
a memory barrier stall.

13. The method of claim 1, wherein speculatively executing the code involves skipping execution of floating-point and other long latency instructions.

14. An apparatus that generates prefetches by speculatively executing code during stalls, comprising:
a processor; and
an execution mechanism within the processor;
wherein upon encountering a stall during execution of code, the execution mechanism is configured to speculatively execute the code from the point of the stall, without committing results of the speculative execution to the architectural state of the processor;
wherein upon encountering a memory reference during the speculative execution of the code, the execution mechanism is configured to,
determine if a target address for the memory reference can be resolved, and
if the target address for the memory reference can be resolved, to issue a prefetch for the memory reference to load a cache line for the memory reference into a cache within the processor.

15. The apparatus of claim 14, wherein the execution mechanism is configured to maintain state information indicating whether values in the registers have been updated during speculative execution of the code.

16. The apparatus of claim 15, wherein the processor includes:
an architectural register file; and
a shadow register file;
wherein during speculative execution of the code, the execution mechanism is configured to ensure that instructions update the shadow register file, instead of updating the architectural register file, so that the speculative execution does not affect the architectural state of the processor.

17. The apparatus of claim 16, wherein the execution mechanism is configured to ensure that a read from a register during speculative execution of the code accesses the architectural register file, unless the register has been updated during speculative execution, in which case the read accesses the shadow register file.

18. The apparatus of claim 15, wherein the execution mechanism is configured to:
maintain a “write bit” for each register, indicating whether the register has been written to during speculative execution; and to
set the write bit of any register that is updated during speculative execution.

19. The apparatus of claim 14, wherein the execution mechanism is configured to maintain state information indicating if the values within the registers can be resolved during speculative execution.

20. The apparatus of claim 19, wherein the execution mechanism is configured to:
maintain a “not there bit” for each register, indicating whether a value in the register can be resolved during speculative execution;
set the not there bit of a destination register for a load during speculative execution if the load has not returned a value to the destination register; and to
set the not there bit of a destination register of an instruction during speculative execution if the not there bit of any source register of the instruction is set.

21. The apparatus of claim 20, wherein while determining if an address for the memory reference can be resolved, the execution mechanism is configured to examine the “not there bit” of a register containing the address for the memory reference, wherein the not there bit being set indicates the address for the memory reference cannot be resolved.

22. The apparatus of claim 14, wherein when the stall completes, the execution mechanism is configured to resume non-speculative execution of the code from the point of the stall.

23. The apparatus of claim 22, wherein while resuming non-speculative execution of the code, the execution mechanism is configured to:
clear “not there bits” associated with the registers;
clear “write bits” associated with the registers;
clear a speculative store buffer; and to
perform a branch mispredict operation to resume execution of the code from the point of the stall.

24. The apparatus of claim 14, wherein the processor includes a speculative store buffer containing data written to memory locations by speculative store operations;
wherein the execution mechanism is configured to allow subsequent speculative load operations directed to the same memory locations to access data from the speculative store buffer.

25. The apparatus of claim 14, wherein the stall can include:
a load miss stall;
a store buffer full stall; and
a memory barrier stall.

26. The apparatus of claim 14, wherein while speculatively executing the code, the execution mechanism is configured to skip execution of floating-point and other long latency instructions.

27. A computer system that generates prefetches by speculatively executing code during stalls, comprising:
a memory;
a processor; and
an execution mechanism within the processor, wherein upon encountering a stall during execution of code, the execution mechanism is configured to speculatively execute the code from the point of the stall, without committing results of the speculative execution to the architectural state of the processor;
wherein upon encountering a memory reference during the speculative execution of the code, the execution mechanism is configured to,
determine if a target address for the memory reference can be resolved, and
if the target address for the memory reference can be resolved, to issue a prefetch for the memory reference to load a cache line for the memory reference into a cache within the processor.
